(19) United States
(12) Patent Application Publication
(10) Pub. No.: US 2009/0123743 A1
(43) Pub. Date: May 14, 2009

(54) Method of manufacture of wire imbedded inlay

(76) Inventors: Guy Shafran, Rosh-Pina (IL); Oded Bashan, Rosh-Pina (IL)

Correspondence Address: ABELMAN, FRAYNE & SCHWAB, 666 THIRD AVENUE, 10TH FLOOR, NEW YORK, NY, 10017, US

(21) Appl. No.: 11/985,529

(22) Filed: Nov. 14, 2007

(51) Int. Cl. B32B 7/12; B32B 37/00

(52) U.S. Cl. 428/344; 156/73.2; 156/60

(57) ABSTRACT

A method of manufacture of wire-embedded inlays, the method including providing a substrate, applying a coating to the substrate, which coating melts at an elevated temperature characteristic of wire-embedding, thereby producing an inlay substrate and when the coating is solid, employing wire embedding techniques for embedding a wire into the inlay substrate.

### FIELD OF THE INVENTION

The present invention relates to methods for the manufacture of wire-embedded inlays and inlays manufactured thereby.

### BACKGROUND OF THE INVENTION

The following published patent documents are believed to represent the current state of the art:

U.S. Pat. Nos. 7,278,580; 7,271,039; 7,269,021; 7,243,840; 7,240,847 and 7,204,427.

### SUMMARY OF THE INVENTION

The present invention seeks to provide an improved method for the manufacture of wire-embedded inlays and improved inlays manufactured thereby.

There is thus provided in accordance with a preferred embodiment of the present invention a method of manufacture of wire-embedded inlays, the method including providing a substrate, applying a coating to the substrate, which coating melts at an elevated temperature characteristic of wire-embedding, thereby producing an inlay substrate and when the coating is solid, employing wire embedding techniques for embedding a wire into the inlay substrate.

Preferably, the method also includes associating electronic circuitry with the embedded wire. Additionally, the electronic circuitry includes a chip module.

Preferably, the applying a coating includes employing a silk screening process for applying the coating.

Preferably, the coating is an adhesive. Additionally, the adhesive is a solvent-based adhesive. Alternatively or additionally, the adhesive is a water-based adhesive.

Preferably, the substrate includes a paper substrate. Alternatively, the substrate includes a plastic substrate.

There is also provided in accordance with another preferred embodiment of the present invention a wire-embedded inlay including an inlay substrate including a substrate coated with a coating which melts at an elevated temperature characteristic of wire-embedding and a wire embedded into the inlay substrate.

Preferably, the wire-embedded inlay also includes electronic circuitry associated with the embedded wire. Additionally, the electronic circuitry includes a chip module.

Preferably, the coating is an adhesive. Additionally, the adhesive is a solvent-based adhesive. Alternatively or additionally, the adhesive is a water-based adhesive.

Preferably, the substrate includes a paper substrate. Alternatively or additionally, the substrate includes a plastic substrate.

### BRIEF DESCRIPTION OF THE DRAWINGS

The present invention will be understood and appreciated more fully from the following detailed description, taken in conjunction with the drawings in which:

FIGS. 1A, 1B, 1C, 1D and 1E are simplified illustrations of steps in a method for the manufacture of wire-embedded inlays in accordance with a preferred embodiment of the present invention.

### DETAILED DESCRIPTION OF A PREFERRED EMBODIMENT

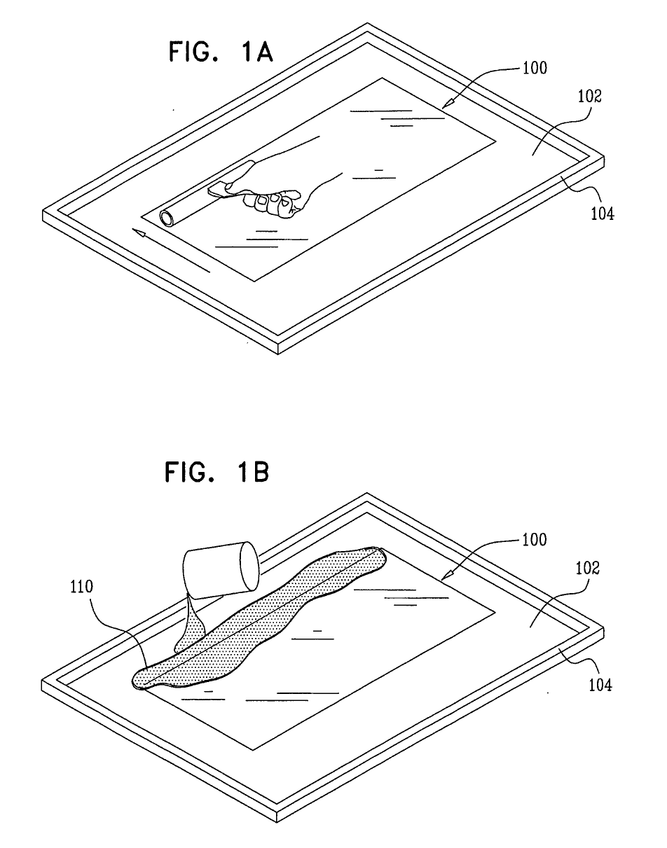

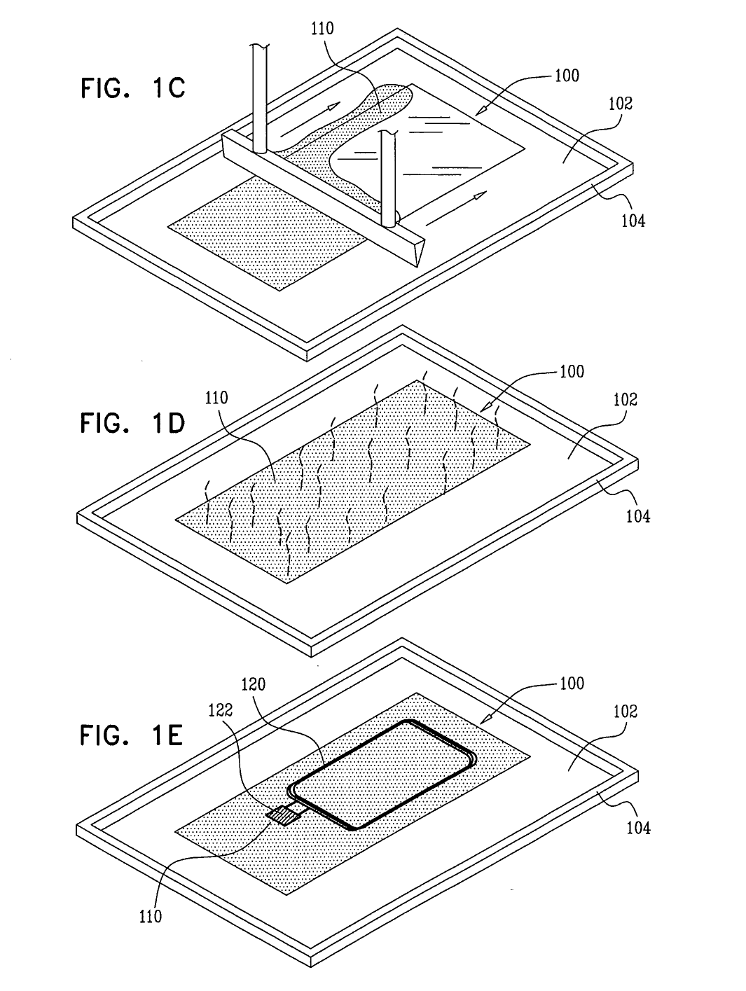

Reference is now made to FIGS. 1A, 1B, 1C, 1D and 1E, which are simplified illustrations of steps in a method for the manufacture of wire-embedded inlays in accordance with a preferred embodiment of the present invention.

As seen in FIG. 1A, a substrate 100, such as paper, plastics, such as PVC (PolyVinyl Chloride), Teslin®, PET-G (PolyEthyleneTerephthalate-Glycol), PET-F (PolyEthyleneTerephthalate-Film), polycarbonate or ABS, and other materials, which are not normally used in conventional ultrasonic wire embedding, is provided. In accordance with a preferred embodiment of the present invention, the substrate 100 is located under a conventional silk-screen net 102, which is supported on a conventional silk-screen frame 104. The silk-screen net 102 is preferably cleaned in order to remove foreign matter therefrom and to reduce static electricity.

In accordance with a preferred embodiment of the present invention, a coating 110, preferably an adhesive, such as a water based or solvent-based adhesive, is applied to the substrate 100 via the silk-screen net 102 by conventional silk screening techniques, as seen in FIGS. 1B and 1C. The coating is preferably allowed to dry, as illustrated in FIG. 1D, and thereafter, as seen in FIG. 1E, preferably using conventional ultrasonic wire embedding techniques, such as those described in U.S. Pat. Nos. 6,628,240; 6,626,364 and 6,604,686, the disclosures of which are hereby incorporated by reference, a wire coil 120 and associated electronic circuitry 122, such as a chip module, are embedded in the coating 110 and thus fixed to the substrate 100. Alternatively non-ultrasonic techniques for embedding or other techniques, such as printing, for providing an antenna may be employed.

It will be appreciated by persons skilled in the art that the present invention is not limited to what has been particularly shown and described hereinabove. Rather the scope of the present invention includes both combinations and subcombinations of various features described hereinabove as well as modifications and variations therein which would occur to a persons skilled in the art and are not in the prior art.

1. A method of manufacture of wire-embedded inlays, the method comprising:
providing a substrate;
applying a coating to the substrate, which coating melts at an elevated temperature characteristic of wire-embedding, thereby producing an inlay substrate; and
when the coating is solid, employing wire embedding techniques for embedding a wire into said inlay coating.

2. A method of manufacture of wire-embedded inlays and wherein said employing wire embedding techniques comprises employing ultrasonic embedding techniques.

3. A method of manufacture of wire embedded inlays according to claim 1 and also comprising associating electronic circuitry with said embedded wire.

4. A method of manufacture of wire embedded inlays according to claim 2 and wherein said electronic circuitry comprises a chip module.

5. A method of manufacture of wire embedded inlays according to claim 1 and wherein said applying a coating comprises employing a silk screening process for applying said coating.

6. A method of manufacture of wire embedded inlays according to claim 1 and wherein said coating is an adhesive.

7. A method of manufacture of wire embedded inlays according to claim 6 and wherein said adhesive is a solvent-based adhesive.

8. A method of manufacture of wire embedded inlays according to claim 6 and wherein said adhesive is a water-based adhesive.

9. A method of manufacture of wire embedded inlays according to claim 1 and wherein said substrate comprises a paper substrate.

10. A method of manufacture of wire embedded inlays according to claim 1 and wherein said substrate comprises a plastic substrate.

11. A wire-embedded inlay comprising:
an inlay substrate including a substrate coated with a coating which melts at an elevated temperature characteristic of wire-embedding; and
a wire associated with said coated inlay substrate.

12. A wire-embedded inlay according to claim 11 and also comprising electronic circuitry associated with said wire.

13. A wire-embedded inlay according to claim 11 and wherein said electronic circuitry comprises a chip module.

13. A wire-embedded inlay according to claim 10 and wherein said coating is an adhesive.

14. A wire-embedded inlay according to claim 13 and wherein said adhesive is a solvent-based adhesive.

15. A wire-embedded inlay according to claim 13 and wherein said adhesive is a water-based adhesive.

16. A wire embedded inlay according to claim 10 and wherein said substrate comprises a paper substrate.

17. A wire embedded inlay according to claim 10 and wherein said substrate comprises a plastic substrate.
